(19) United States
(12) Patent Application Publication
(10) Pub. No.: US 2010/0282486 A1
(43) Pub. Date: Nov. 11, 2010

(54) Wire Heat-Shrink Tube for Concentration Photovoltaic Module

(75) Inventors: Hwa-Yuh Shin, Longtan Shiang (TW); Hung-Zen Kuo, Longtan Shiang (TW); Chua-Yi Chen, Longtan Shiang (TW)

Correspondence Address: Jackson Intellectual Property Group PLLC, 106 Starvale Lane, Shipman, VA, 22971, US

(73) Assignee: ATOMIC ENERGY COUNCIL-INSTITUTE OF NUCLEAR ENERGY RESEARCH, Taoyuan (TW)

(21) Appl. No.: 12/637,936

(22) Filed: Dec. 15, 2009

(30) Foreign Application Priority Data
May 7, 2009 (TW) 098115081

(51) Int. Cl. H01R 4/72

(52) U.S. Cl. 174/85

(57) ABSTRACT

A wire heat-shrink tube is fabricated for concentration photovoltaic module. The tube is made of transparent heat resisting material and is covered over a joint of two wires. The tube will not be burnt by concentrated light. Thus, solar cells using the tube are reliable and have a high quality.

### FIELD OF THE INVENTION

The present invention relates to a heat-shrink tube; more particularly, relates to a heat-shrink tube with transparency and heat-resistance covered over a joint of wires to be used in a concentration photovoltaic module.

### DESCRIPTION OF THE RELATED ARTS

On wiring in a concentration photovoltaic module, extra wire is usually used for prolonging connection. In FIG. 3, two wires 3 are connected. At a joint, an isolation layer is stripped off to bare the wires 3; and, then, the wire cores 32 of the wires 3 are soldered. For isolation, a heat-shrink tube 4 is covered over the joint to prevent short circuiting and leakage. However, the concentration photovoltaic module collects light at a focal point to inlet light on a small surface for photo-electric conversion and the temperature at the focal point may be raised up to more than one hundred Celsius degrees. When the focal point lies at the heat-shrink tube covered over the joint of the wires 3, the heat-shrink tube 4 may be worn since it is not transparent and is not heat-resistant. After time passes, heat is aggregated to burn the heat-shrink tube and short-circuiting and leakage may happen. Therefore, a protective layer 5 is added to resist the heat. Yet, the production procedure thus becomes complex and cost is raised. Hence, the prior art does not fulfill all users' requests on actual use.

### SUMMARY OF THE INVENTION

The main purpose of the present invention is to provide a heat-shrink tube with transparency and heat-resistance covered over a joint of two wires to be used in a concentration photovoltaic module.

To achieve the above purpose, the present invention is a wire heat-shrink tube for concentration photovoltaic module, comprising two connected wires; and a heat-shrink tube, where the heat-shrink tube is covered over a joint of the wires, the wires are wires in a concentration photovoltaic module; and the heat-shrink tube is transparent and is made of a heatproof material. Accordingly, a novel wire heat-shrink tube for concentration photovoltaic module is obtained.

### BRIEF DESCRIPTIONS OF THE DRAWINGS

The present invention will be better understood from the following detailed description of the preferred embodiment according to the present invention, taken in conjunction with the accompanying drawings, in which

FIG. 1 is the component view showing the preferred embodiment according the present invention;

FIG. 2 is the perspective view showing the preferred embodiment; and

FIG. 3 is the view of the prior art.

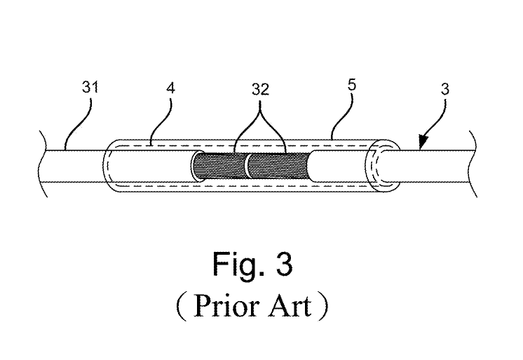

### DESCRIPTION OF THE PREFERRED EMBODIMENT

The following description of the preferred embodiment is provided to understand the features and the structures of the present invention.

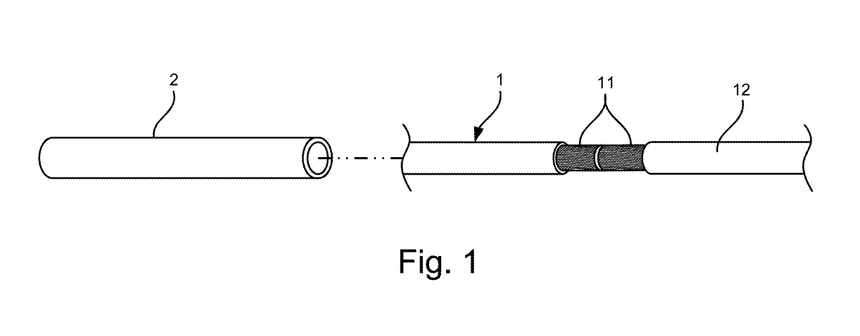

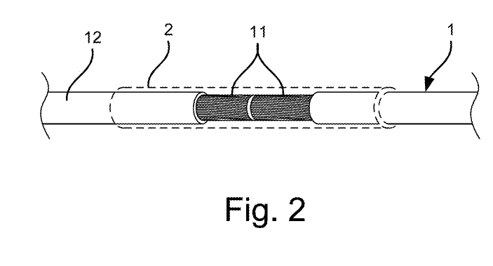

Please refer to FIG. 1 and FIG. 2, which are a component view and a perspective view showing a preferred embodiment according the present invention. As shown in the figures, the present invention is a wire heat-shrink tube for concentration photovoltaic module, where a heat-shrink tube 2 is covered over a joint of two connected wires 1; the wires 1 are used in a concentration photovoltaic module; and the heat-shrink tube is transparent and is made of a heatproof material.

Therein, the heat-shrink tube 2 can be covered over the whole wire 1; then, a section of the heat-shrink tube 2 can be cut to be covered over a joint of the connected wires 1. Thus, a novel wire heat-shrink tube for concentration photovoltaic module is obtained.

The wire 1 used in the concentration photovoltaic module comprises a wire core 11 and a wire material 12, where the wire core conducts current; the wire material 12 is a transparent or white material; and the wire material 12 is covered over the wire core 11 for isolation. The wire material 12 at the joint of the wires 1 is stripped off. The two wires 1 are connected at the joint through soldering and then the heat-shrink tube 2 is covered over the joint. Thus, when current is conducted, short circuiting and leakage will not be caused by the bare wire cores 11 of the wires 1.

On using the present invention, an inlet light is shone on the heat-shrink tube 2 over the joint of the wires 1. The inlet light then passes through the heat-shrink tube 2 and is shone on the wires 1. Thus, energy of the light is not gathered in the heat-shrink tube 2 to burn the heat-shrink tube 2. Furthermore, the wire materials 12 of the wires 1 are transparent or white materials, so the light energy gathered on the wire material 12 by the concentration photovoltaic module is directly reflected. Hence, the wires 1 will not be burnt on gathering energy.

The heat-shrink tube used in the present invention is transparent and heat-resistant and is covered over the joint of the wires. Thus, the production cost is reduced and reliability and quality of the concentration photovoltaic module is improved.

To sun up, the present invention is a wire heat-shrink tube for concentration photovoltaic module, where a heat-shrink tube with transparency and heat-resistance is covered over a joint of wires; and, thus, production cost is reduced and reliability and quality of a concentration photovoltaic module is improved.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A wire heat-shrink tube for concentration photovoltaic module comprising
a plurality of connected wires; and
a heat-shrink tube, said heat-shrink tube being covered over a joint of said wires,
wherein said wires are wires in a concentration photovoltaic module; and
wherein said heat-shrink tube is transparent and is made of a heatproof material.

2. The tube according to claim 1,
wherein said heat-shrink tube has a heat-resistant temperature reaching 150 Celsius degrees (° C.).

3. A wire heat-shrink tube for concentration photovoltaic module comprising
a plurality of connected wires; and
a heat-shrink tube, said heat-shrink tube being covered over each of said wires,
wherein said wires are wires in a concentration photovoltaic module;
wherein a section of said heat-shrink tube is cut to be covered over a joint of said wires; and
wherein said heat-shrink tube is transparent and is made of a heatproof material.

4. The tube according to claim 3,
wherein said heat-shrink tube has a heat-resistant temperature reaching 150° C.
